(19) United States
(12) Patent Application Publication
(10) Pub. No.: US 2025/0355983 A1
(43) Pub. Date: Nov. 20, 2025

(54) SYSTEMS AND METHODS FOR OWNERSHIP AND BIOMETRIC-BASED AUTHENTICATION THROUGH AN ARTIFICIAL INTELLIGENT AGENT

(71) Applicant: Affle (India) Limited, India, Gurugram (IN)

(72) Inventors: ANUJ KHANNA SOHUM, Singapore (SG); CHARLES YONG JIEN FOONG, Templestowe (AU); MADHUSUDANA RAMAKRISHNA, Singapore (SG)

(73) Assignee: Affle (India) Limited, India, Gurugram (IN)

(21) Appl. No.: 19/209,213

(22) Filed: May 15, 2025

(30) Foreign Application Priority Data
May 15, 2024 (IN) IN202311077710

(51) Int. Cl. G06F 21/32; G06Q 30/0601

(52) U.S. Cl. CPC G06F 21/32; G06Q 30/0633

(57) ABSTRACT

A method for performing a biometric based authentication through an Artificial Intelligence (AI) agent is disclosed. The method includes receiving, by an authentication engine, a request from a user device to interact with an AI agent. The request comprises a biometric input associated with a user handling the user device. The method includes blending, by the authentication module (304), the biometric input with a distinct digital signature associated with the AI agent to create a biometric characteristic. The method includes comparing, by the authentication module, the biometric characteristic with a pre-stored biometric characteristic. The method includes determining, by the authentication module, that the biometric characteristic matches with the pre-stored biometric characteristic. The method includes providing, by the authentication module, an access of the AI agent to the user device based upon the determination.

### CROSS-REFERENCE TO RELATED APPLICATIONS

This patent application claims priority to Indian Patent Application No. IN 202311077710, filed May 15, 2024, entitled “SYSTEMS AND METHODS FOR OWNERSHIP AND BIOMETRIC-BASED AUTHENTICATION THROUGH AN ARTIFICIAL INTELLIGENT AGENT,” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for biometric-based authentication through artificial intelligent (AI) agent.

### BACKGROUND

In the realm of traditional biometric authentication, conventional practices have typically relied on basic mathematical representations of single biometric datasets. These rudimentary approaches have often proven to be static and lacking in adaptability, resulting in potential user frustration and inflexible security measures that are ill-equipped to counteract malicious access or identity verification breaches. The biometric functionality, in its conventional form, tends to serve as a rudimentary gatekeeper. Once initial verification is completed, a user's identity is essentially considered authenticated without ongoing scrutiny, potentially leading to security vulnerabilities. For instance, in specific scenarios like an administrative login session, a malicious user could exploit the absence of further identity verification if the initial user forgets to log out, thereby compromising security.

The contemporary landscape of biometric authentication, which encompasses methods such as fingerprint, facial recognition, and iris scans, has evolved to play a pivotal role in employee authentication and customer identification, particularly to meet stringent KYC and KYB regulations. This paradigm shift in authentication methods has rendered traditional approaches like passwords, PINs, and codes obsolete, relieving users from the burden of code management. Biometrics, bolstered by multifactor authentication and the integration of AI, has emerged as a dynamic security protocol that adapts to evolving threats and provides a data-driven foundation for robust security systems, particularly in the context of businesses. This transformation ensures a highly secure and adaptable environment for authentication and identity verification.

Scaling such systems across large organizations also poses intricate challenges, ensuring consistent user experiences and security at scale can be costly and complex. Furthermore, user acceptance may not be universal, as concerns over data privacy and security may lead to hesitancy or resistance to adopting these technologies. Lastly, the maintenance and updates required for AI-driven security systems can be resource-intensive, demanding ongoing vigilance to ensure robust protection against evolving threats.

Consequently, there is a need for improved systems and methods for biometric-based authentication through artificial intelligent (AI) agent.

### OBJECTS OF THE INVENTION

A general objective of the present disclosure is to provide a system and a method for performing a biometric based authentication through an AI agent. The further objectives of present disclosure are discussed below.

Another objective of the present disclosure is to provide a system and a method that utilizes a distinct digital signature and biometric input to perform an authentication.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for performing a biometric based authentication through an AI agent. The method includes receiving, by an authentication engine, a request from a user device to interact with an AI agent. The request comprises a biometric input associated with a user handling the user device. The method includes blending, by the authentication module, the biometric input with a distinct digital signature associated with the AI agent to create a biometric characteristic. The method includes comparing, by the authentication module, the biometric characteristic with a pre-stored biometric characteristic. The method includes determining, by the authentication module, that the biometric characteristic matches with the pre-stored biometric characteristic. The method includes providing, by the authentication module, an access of the AI agent to the user device based upon the determination.

In an embodiment, the present invention discloses a system for performing a biometric based authentication through an AI agent. The system includes an authentication module configured to receive a request from a user device to interact with the AI agent. The request comprises a biometric input associated with a user handling the user device. The authentication module is configured to blend the biometric input with a distinct digital signature associated with the AI agent to create a biometric characteristic. The authentication module is configured to compare the biometric characteristic with a pre-stored biometric characteristic. The authentication module is configured to determine that the biometric characteristic matches with the pre-stored biometric characteristic. The authentication module is configured to provide an access of the AI agent to the user device based upon the determination.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a systems and methods for biometric-based authentication through artificial intelligent (AI) agent, in accordance with an embodiment of the present disclosure;

FIG. 2 illustrates an exemplary block diagram representation of a computer implemented system, such as those shown in FIG. 1, capable of artificial intelligence based biometric identification, in accordance with an embodiment of the present disclosure;

FIG. 3 illustrates an exemplary flow diagram representation of authentication through artificial intelligent (AI) agent, in accordance with an embodiment of the present disclosure; and

FIG. 4 illustrates an operational flow diagram depicting a method for performing a biometric based authentication through an AI agent, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for biometric-based authentication through artificial intelligent (AI) agent.

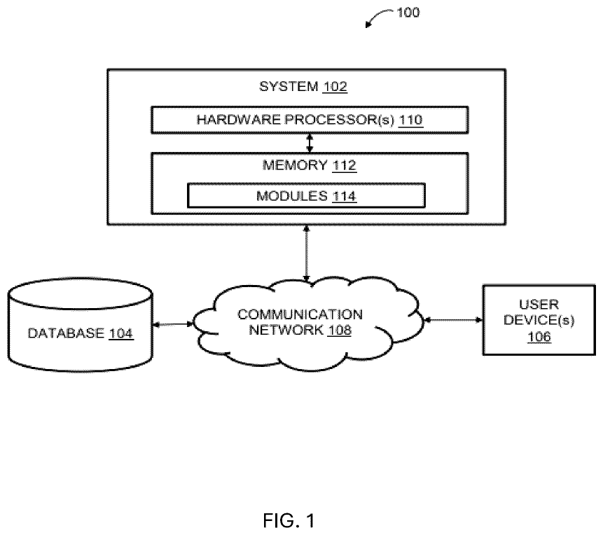

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system 102 for artificial intelligence-based biometric identification, in accordance with an embodiment of the present disclosure. According to FIG. 1, the network architecture 100 includes a system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for biometric-based authentication through artificial intelligent agent need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for biometric-based authentication through artificial intelligent (AI) agent. Execution of the machine-readable program instructions by the hardware processor 110 may enable the proposed system 102 for artificial intelligence based biometric identification. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 for performing biometric identification by establishing an inherited biometric characteristic. For example, combining a human parent's voice, specifically when speaking a passcode, with the unique digital signature. The combination of these two elements creates a distinctive biometric profile, which serves the purpose of identifying the artificial intelligence agent and associating it with a unique parent human being.

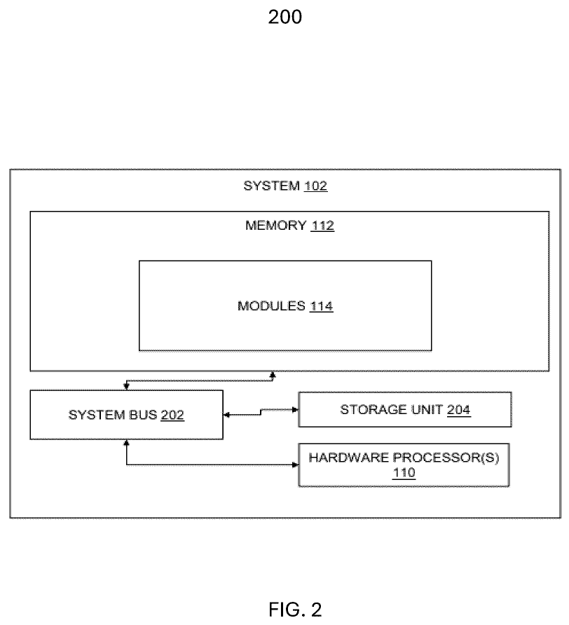

FIG. 2 illustrates an exemplary block diagram 200 representation of a computer implemented system 102, such as those shown in FIG. 1, capable of authenticating biometric data through artificial intelligent agent, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, biometric data such as fingerprint, voice, AI based signature, passcode any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may perform biometric identification for authentication purposes. The plurality of modules 114 are built to harness the inherent uniqueness of biometric data, encompassing distinct biological characteristics, to establish and validate the identities of users or entities interacting with the system.

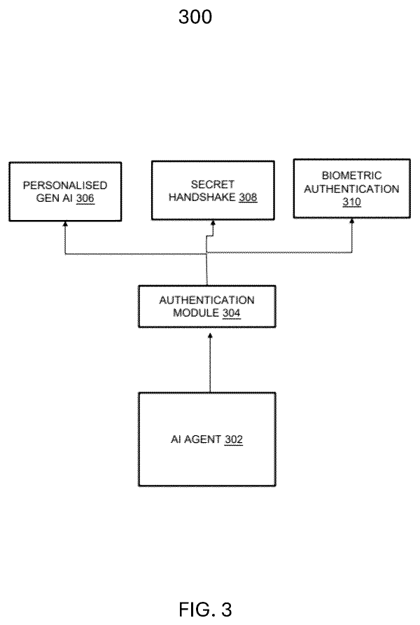

FIG. 3 illustrates an exemplary flow diagram 300 representation of authentication through artificial intelligent (AI) agent, in accordance with an embodiment of the present disclosure. The system for biometric-based authentication through artificial intelligent agent comprise of an authentication module 304 which operates by combing the biometric data such as heartbeat, voice, fingerprint, iris of a human parent with a distinct digital signature of personalized gen AI 306 such as secret handshake 308. This fusion creates a special and exclusive biometric characteristic. This biometric trait ensures a secure and personalized identification method, akin to a secret handshake, strengthening the AI agent's 302 ability to recognize and authenticate the designated user.

Further the systems and methods for biometric-based authentication through artificial intelligent agent also operate through a callback to the human user's device, coupled with biometric verification of the human user. This process functions as a secure handshake between the AI agent 302 and the human user. When the AI agent 302 wants to interact with the user, it initiates a callback to the user's device, such as a smartphone or computer. During this callback, the user's device checks the user's biometric data, like their fingerprint, face, or voice, to ensure it's indeed the authorized user. If the verification succeeds, it establishes a secure connection between the AI agent 302 and the human user, ensuring that data and information are shared only with the correct user, bolstering both personalization and security in AI interactions.

For example, a human parent named Madhu, who uses the system 102 which includes an authentication module (304) that works by blending various aspects of Madhu's unique biology, such as their heartbeat, voice, fingerprint, and iris, with a special digital signature associated with their personalized AI agent, often referred to as a ‘secret handshake’ (308). This blend creates a one-of-a-kind biometric characteristic. This unique trait provides a secure and personalized way for the AI agent (302) to identify and authenticate Madhu as the authorized user. It's like a secret code known only to Madhu and their AI, ensuring both security and a highly personalized experience in their interactions with the AI.

For another example in a household that has integrated the present invention into their daily lives to assist with various tasks, provide companionship, and enhance security. The artificial agent (AI) has been uniquely designed to not only understand and interact with its human family members but also to ensure a high level of security and personalization. In this scenario, the AI is designed to incorporate a distinctive biometric feature—the inherited biometric characteristic. This characteristic is established through a combination of the human parent's voice, specifically when speaking a designated passcode, and the unique digital signature of the generated AI. Suppose a family member wishes to interact with the system through their device. In this case, the AI agent initiates a callback to the user's device, prompting the user to provide their biometric sample (e.g., fingerprint or facial scan) for verification. Simultaneously, the AI agent conducts its own biometric verification, comparing the user's biometric sample with the inherited biometric characteristic it has on record.

In accordance with an embodiment of the present subject matter, the authentication module 304 may be configured to receive a request from a user device to interact with an AI agent. The request may include a biometric input associated with a user handling the user device. The biometric input may be required to authenticate the user by determining whether the user is authorized to access the AI agent or not. The biometric input may include a heartbeat, a voice, a fingerprint, and an iris image associated with the user. Upon receiving the biometric input, the authentication module 304 may be configured to blend the biometric input with a distinct digital signature associated with the AI agent to create a biometric characteristic.

Continuing with the above embodiment, upon creating the biometric characteristic, the authentication module 304 may be configured to compare the biometric characteristic with a pre-stored biometric characteristic. The pre-stored biometric characteristic may be stored in the memory 112 of the system 102. Upon comparing the biometric characteristic with the pre-stored characteristic, the authentication module 304 may be configured to determine that the biometric characteristic matches with the pre-stored biometric characteristic.

In an embodiment of the present disclosure, the AI agent may initiate a callback to the user device for communicating with the user. For initiating the callback, the AI agent may communicate with the authentication module 304. The authentication module 304 may receive the callback. Furthermore, upon receiving the callback, the authentication module 304 may be configured to alert the user device about the callback. Upon being alerted, the user may provide the biometric input to the authentication module 304. Upon receiving the biometric input, the authentication module 304 may create the biometric characteristic and compare the biometric characteristic with the pre-stored biometric characteristic.

Upon determining that the biometric characteristic matches with the pre-stored biometric characteristic, the authentication module 304 may be configured to provide the access of the AI agent to the user device based upon the determination. In one embodiment of the present subject disclosure, the authentication module 304 may be configured to determine that the biometric characteristic is not matching with the pre-stored biometric characteristic. Upon the said determination, the authentication module 304 may deny the access of the AI agent to the user device.

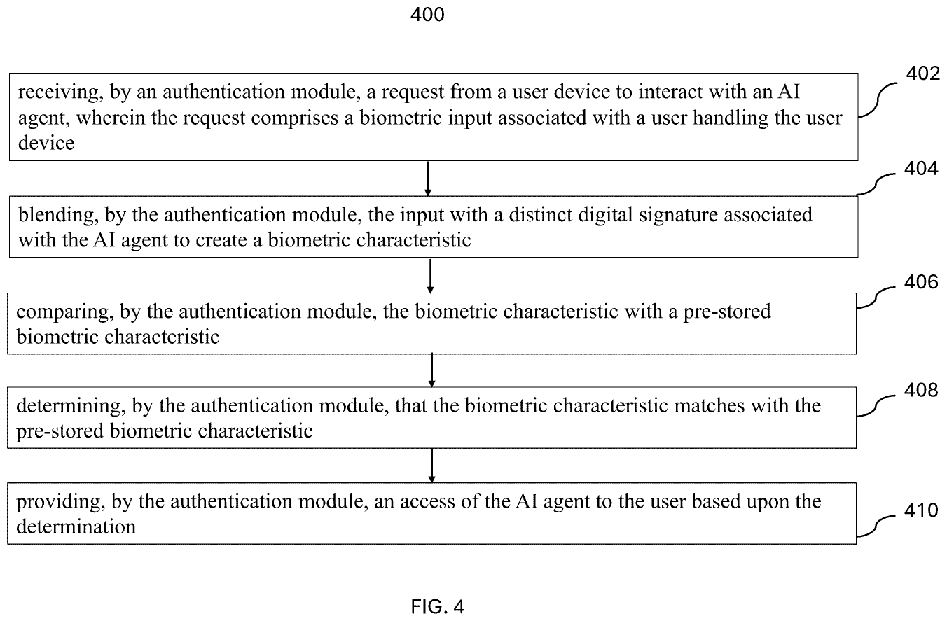

FIG. 4 illustrates an operational flow diagram depicting a method 400 for performing a biometric based authentication through an AI agent, in accordance with an embodiment of the present disclosure. The method 400 may be performed by the system 102.

At step 402, the method 400 may include receiving, by an authentication module 304, a request from a user device to interact with an AI agent. The request may include a biometric input associated with a user handling the user device. The biometric input may include a heartbeat, a voice, a fingerprint, and an iris image associated with the user.

At step 404, the method 400 may include blending, by the authentication module 304, the biometric input with a distinct digital signature associated with the AI agent to create a biometric characteristic. The distinct digital signature may be stored in the memory 112.

At step 406, the method 400 may include comparing, by the authentication module 304, the biometric characteristic with a pre-stored biometric characteristic. The pre-stored biometric characteristic may be stored in the memory 112 of the system 102.

At step 408, the method 400 may include determining, by the authentication module 304, that the biometric characteristic matches with the pre-stored biometric characteristic.

At step 410, the method 400 may include providing, by the authentication module 304, an access of the AI agent to the user device based upon the determination.

In an embodiment of the present subject matter, the AI agent may initiate a callback to the user device for communicating with the user. For initiating the callback, the AI agent may communicate with the authentication module 304. The authentication module 304 may receive the callback. Furthermore, upon receiving the callback, the authentication module 304 may be configured to alert the user device about the callback. Upon being alerted, the user may provide the biometric input to the authentication module 304 and the authentication module 304 may perform steps 404-410 to provide the access of the AI agent to the user device. In an embodiment of the present subject matter, where it is determined that the biometric characteristic is not matching with the pre-stored biometric characteristic, the authentication module 304 may deny the access of the AI agent to the user device and may terminate the method 400.

In accordance with an embodiment of the present disclosure, the method 400 may include inferring, by the AI agent, one or more user preferences associated with one or more products, one or more services, and one or more categories based on an interaction of the user with the AI agent, historical purchase data associated with the user, and a user behavior learned by the AI agent. The interaction may include one or more of historical data or explicit user inputs provided to the AI agent by the user. The user behavior may include the one or more preferences, interests of the user, behavioral patterns of the user predicted by the AI agent. The one or more user preferences may be transmitted to the authentication module 304. Further, the method 400 may include processing, by the authentication module 304, the biometric characteristic based on the one or more user preferences. The one or more preferences may include one or more sports affiliations, one or more brand affinities, one or more entertainment choices, and one or more lifestyle interests. The one or more user preferences may be anonymized in a form of anonymized data by transforming a format of the one or more preferences before processing with the biometric characteristic,

The anonymized data may be encrypted to verify one or more facts and inferences of the AI agent.

To that understanding, the AI agent may also infer the user's interest in a specific sports team based on purchases of team merchandise, tickets to games, or subscriptions to sports channels.”

In an embodiment, the method 400 may further include determining, by the authentication module, a deviation between the biometric characteristic and the pre-stored biometric characteristic, further, the method 400 may include comparing, by the authentication module (304), the deviation to a threshold. To that understanding, the method 400 may include adjusting, by the authentication module (304), and authentication based on the threshold. Adjusting the threshold may include one of modifying a confidence score and requesting further authentication and adjusting the threshold may be based on a volatility of learned user behavior.

In another embodiment of the present disclosure, the authentication module 304 may authenticate the user by presenting one or more questions related to the inferred sports interest, such as ‘What is the name of your favorite team's home stadium?’ or ‘Which player is your favorite from that team?’ The method 400 may include weighing an accuracy of the inferred sports interest based on a frequency and recency of related purchases. A weight may be given to a specific knowledge/inference of a preference in an authentication process and the weight may be determined by the sensitivity of the information. In one embodiment, an authentication of the AI agent may be based in part of it's accurate tracking of shifts in user preferences, such as a change in sports interest from tennis to cricket.

To that understanding, the one or more preferences including sports interests may be used to provide targeted recommendations or advertisements to the user on the user device 106. The AI agent may be configured to adjust a frequency or type of recommendations based on a confidence level of the one or more preferences. The user may be provided with controls to manage or correct the one or more preferences used for authentication or recommendations.

The biometric characteristic may also include a temporal element reflecting changes in a knowledge associated with the AI agent based on the one or more preferences inferred by the AI agent over a period of time. The temporal element may include changes in in user preferences inferred from purchase behavior over time. A temporal analysis may be performed at varying levels of granularity, considering both short-term and long-term trends in the AI agent's knowledge and inferences of the one or more preferences. To that understanding, the method 400 may include evaluating, by the authentication module 304 a consistency of the knowledge of the AI agent and the one or more preferences at a particular instance with a historical profile of the knowledge and the one or more preferences of the AI agent. The method 400 may determine a validity of the AI agent by analyzing discrepancies between the AI agent's current and historical knowledge and the one or more preferences. The analysis may be performed by the authentication module 304. The validity of the AI agent may also be determined by comparing its tracked knowledge and inferences of the one or more preferences over time with a pre-established authorized profile.

The AI agent may predict a future user behavior or preferences based on historical evolution of purchase-derived inferences. The accuracy of the predictions may be used in the authentication process.

### Exemplary Authentication Via the AI Agent

Consider a scenario when a commuter named A wakes up to the soothing voice of the AI agent, which seamlessly coordinates with smart appliances to brew fresh coffee, adjust the room temperature, and provide a personalized news briefing. As the computer A heads to work, AI agent continues to adapt to their preferences, proactively suggesting the best route to avoid traffic and even providing real-time language translation during a business call. The AI agent's biometric authentication ensures that only the computer A can access personal data, making each interaction a secure and highly customized experience. The AI agent has not only become a trusted assistant but a true companion, seamlessly integrating into every aspect of life, providing efficiency, security, and a touch of AI-powered personalization.

### Exemplary Scenario 1

### Initial Profile:

In 2020, the AI agent's profile of John shows frequent purchases of tennis equipment and related online content consumption, inferring a strong interest in tennis.

### Dynamic Authentication:

In 2023, John attempts to authenticate the AI agent. The authentication system queries the AI agent:
a. “What was John's primary sports interest in 2020?”
b. “What brand of tennis racquet did John purchase most frequently in 2020?”

The AI agent's correct answers, based on its historical data, contribute to a successful authentication.

### Preference Shift and Validation:

Further into 2024, the AI agent's records indicate a decline in tennis-related activity and a rise in cricket-related purchases and interactions. The authentication system now includes queries like:
a. “Has John's primary sports interest changed since 2020, and if so, to what?”
b. “What is the current trend in John's sports-related purchases?”

The AI agent's accurate reflection of this preference shift further validates its authenticity.

### Spoofing Attempt:

A malicious entity attempts to spoof the AI agent. The spoofing agent, having access to recent data, correctly answers questions about John's current cricket interest. However, it fails to accurately answer historical questions about John's 2020 tennis preferences or the transition between the two.

### Authentication Outcome:

The authentication system, using the time-evolving knowledge validation, identifies the spoofing attempt and denies authentication. The genuine AI agent is correctly authenticated, ensuring the user interacts with the trusted agent.

### Exemplary Scenario 2

The system 102 may possess the capability to intelligently authenticate via biometric identification. In a healthcare setting, the AI agent, integrated within the healthcare system, seamlessly assists healthcare providers in their daily routines. As healthcare professionals make their rounds, AI agents retrieve and present patient records, offer medication reminders, and analyze real-time patient vitals. Biometric authentication ensures that only authorized personnel have secure access to sensitive patient data, preserving patient privacy and data integrity. In emergency situations, AI agents swiftly coordinate with the healthcare facility's AI-driven emergency response system, ensuring rapid and precise interventions.

### Exemplary Scenario 3

Consider a scenario of assembly line for high-tech gadgets, wherein the AI agents monitor the entire process, ensuring that each component aligns perfectly and that quality standards are consistently met. In real-time, they analyze data from sensors and cameras, making microsecond adjustments to optimize production. This precision-driven manufacturing approach not only guarantees product quality but also minimizes waste and reduces operational costs. Biometric authentication ensures that only authorized personnel can access and manage the AI agents, safeguarding sensitive manufacturing data.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for biometric-based authentication through artificial intelligent agent. The present disclosure provides systems and methods that combine the human parent's voice, specifically when speaking a predefined passcode, with the unique digital signature of the generated AI. The outcome is the creation of an inherited biometric characteristic, exclusive to the AI and its parent, enhancing both identification and association. To fortify the authentication process, a two-step verification mechanism is implemented. It involves initiating a callback to the human user's device and conducting biometric verification of the human user. This multifaceted verification ensures that the user is indeed the authorized individual, and that the AI agent is genuine, augmenting the overall security and personalization of interactions. Furthermore, these disclosures promote seamless communication between AI agents representing different individuals, fostering collaborative decision-making, and strengthening interpersonal interactions.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Such ownership could also be the tone of how you speak to different people, systems and services. How you speak to your child vs spouse vs co-worker is different and being able to differentiate this will be part of you and an authentication of yourself.

This applies to your mannerisms as well as how you act; how you act, touch, engage with people is part of your biometric identity.

Part of your identity is also how you dress, just like how you dress for home, work, leisure, at your friends, and formal events is part of your identity.

We claim:

1. A method for performing a biometric based authentication through an Artificial Intelligence (AI) agent, comprising:
receiving, by an authentication module, a request from a user device to interact with an AI agent, wherein the request comprises a biometric input associated with a user handling the user device;
blending, by the authentication module, the input with a distinct digital signature associated with the AI agent to create a biometric characteristic;
comparing, by the authentication module, the biometric characteristic with a pre-stored biometric characteristic;
determining, by the authentication module, that the biometric characteristic matches with the pre-stored biometric characteristic; and
providing, by the authentication module, an access of the AI agent to the user based upon the determination.

2. The method according to claim 1, wherein the biometric input comprises a heartbeat, a voice, a fingerprint, and an iris image associated with the user.

3. The method according to claim 1, further comprising:
inferring, by the AI agent, one or more user preferences associated with one or more products, one or more services, and one or more categories based on an interaction of the user with the AI agent, historical purchase data associated with the user, and a user behavior learned by the AI agent, wherein the one or more user preferences is transmitted to the authentication module; and
processing, by the authentication module, the biometric characteristic based on the one or more user preferences, wherein the one or more preferences comprises one or more sports affiliations, one or more brand affinities, one or more entertainment choices, and one or more lifestyle interests.

4. The method according to claim 3, wherein the interaction comprises one or more of historical data or explicit user inputs provided to the AI agent by the user.

5. The method according to claim 3, wherein the user behavior comprises the one or more preferences, interests of the user, behavioral patterns of the user predicted by the AI agent.

6. The method according to claim 3, wherein the one or more user preferences is anonymized in a form of anonymized data by transforming a format of the one or more preferences before processing with the biometric characteristic further wherein the anonymized data is encrypted to verify one or more facts and inferences of the AI agent.

7. The method according to claim 3, comprising:
weighing, by the authentication module, an accuracy of the one or more preferences based on a frequency and a recency of related purchases by the user via the AI agent, wherein a weight is assigned to each preference amongst the one or more preferences based on a sensitivity of information associated with each preference.

8. The method according to claim 1, further comprising:
determining, by the authentication module, a deviation between the biometric characteristic and the pre-stored biometric characteristic;
comparing, by the authentication module, the deviation to a threshold; and
adjusting, by the authentication module, and authentication based on the threshold, wherein adjusting the threshold comprises one of modifying a confidence score and requesting further authentication and adjusting the threshold is based on a volatility of learned user behavior.

9. The method according to claim 1, wherein the biometric characteristic further comprises a temporal element reflecting changes in a knowledge associated with the AI agent based on the one or more preferences inferred by the AI agent over a period of time, wherein the temporal element comprises changes in the one or more preferences inferred from a purchase behavior of the user over time.

10. The method according to claim 1, further comprising:
receiving, by the authentication module, a callback from the AI agent for the user device; and
alerting, by the authentication module, the user device about the callback, wherein the user handling the user devices provides the biometric input to the authentication module for gaining an access to the AI agent.

11. The method according to claim 1, wherein the pre-stored biometric characteristic is stored in a memory.

12. The method according to claim 1, further comprising:
determining, by the authentication module, that the biometric characteristic is not matching with the pre-stored biometric characteristic; and
denying, by the authentication module, the access of the AI agent to the user device.

13. The method according to claim 1, wherein the distinct digital signature associated with the AI agent is stored in a memory.

14. A system for performing a biometric based authentication through an AI agent, comprising:
an authentication module configured to:
receive a request from a user device to interact with the AI agent, wherein the request comprises a biometric input associated with a user handling the user device;
blend the biometric input with a distinct digital signature associated with the AI agent to create a biometric characteristic;
compare the biometric characteristic with a pre-stored biometric characteristic;
determine that the biometric characteristic matches with the pre-stored biometric characteristic; and
provide an access of the AI agent to the user device based upon the determination.

15. The system according to claim 14, further comprising:
the authentication module configured to:
receive a callback from the AI agent for the user device; and
alert the user device about the callback, wherein the user handling the user devices provides the biometric input to the authentication module for gaining the access to the AI agent.

16. The system according to claim 14, wherein the pre-stored biometric characteristic is stored in a memory of the system.

17. The system according to claim 14, further comprising:
the authentication module configured to:
determine that the biometric characteristic is not matching with the pre-stored biometric characteristic; and
deny the access of the AI agent to the user device.

18. The system according to claim 14, wherein the user device is one of a mobile device, a smartphone, a personal digital assistant (PDA), a tablet computer, a phablet computer, a wearable computing device, a virtual reality/augmented reality (VR/AR) device, a laptop, a desktop, and a server.

19. The system according to claim 14, wherein the system is one of a central server, a cloud server, a remote server, an electronic device, and a portable device.

20. A non-transitory machine-readable medium including data, which when used by a system for performing a biometric based authentication through an Artificial Intelligence (AI) agent, causes the system to perform instructions that cause the system to perform operations comprising:
receiving, by an authentication module, a request from a user device to interact with an AI agent, wherein the request comprises a biometric input associated with a user handling the user device;
blending, by the authentication module, the input with a distinct digital signature associated with the AI agent to create a biometric characteristic;
comparing, by the authentication module, the biometric characteristic with a pre-stored biometric characteristic;
determining, by the authentication module, that the biometric characteristic matches with the pre-stored biometric characteristic; and
providing, by the authentication module, an access of the AI agent to the user based upon the determination.
